(19) United States
(12) Patent Application Publication
(10) Pub. No.: US 2025/0110879 A1
(43) Pub. Date: Apr. 3, 2025

(54) PARTITIONED HOME SNOOP FILTER

(71) Applicant: Intel Corporation, Santa Clara, CA (US)

(72) Inventors: Kiran Kumar Akella, Hyderabad (IN); Sai Prashanth Muralidhara, Portland, OR (US); Devyani Ghosh, Campbell, CA (US); Robert G. Blankenship, Tacoma, WA (US)

(73) Assignee: Intel Corporation, Santa Clara, CA (US)

(21) Appl. No.: 18/478,875

(22) Filed: Sep. 29, 2023

(51) Int. Cl. G06F 12/0831; G06F 12/0846

(52) U.S. Cl. CPC G06F 12/0831; G06F 12/0848

(57) ABSTRACT

Techniques for partitioned home snoop filtering are described. In an embodiment, an apparatus includes multiple caching agent circuits and a home agent circuit. The home agent circuit controls cache coherency using a snoop filter including multiple partitions, each corresponding to a corresponding one of the caching agent circuits.

### BACKGROUND

Computers and other information processing systems may include multiple cache memories, multiple caching agents, and one or more home agents that use a snoop filter to help control coherent access to memory space.

### BRIEF DESCRIPTION OF DRAWINGS

Various examples in accordance with the present disclosure will be described with reference to the drawings, in which:

FIG. 1 illustrates a monolithic home snoop filtering architecture.

FIG. 2 illustrates a partitioned home snoop filtering architecture according to an embodiment.

FIG. 3 illustrates a method for partitioned snoop filtering according to an embodiment.

FIG. 4 illustrates an example computing system.

FIG. 5 illustrates a block diagram of an example processor and/or System on a Chip (SoC) that may have one or more cores and an integrated memory controller.

FIG. 6A is a block diagram illustrating both an example in-order pipeline and an example register renaming, out-of-order issue/execution pipeline according to examples.

FIG. 6B is a block diagram illustrating both an example in-order architecture core and an example register renaming, out-of-order issue/execution architecture core to be included in a processor according to examples.

FIG. 7 illustrates examples of execution unit(s) circuitry.

FIG. 8 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media for snoop filtering. According to some examples, an apparatus includes multiple caching agent circuits and a home agent circuit. The home agent circuit controls cache coherency using a snoop filter including multiple partitions, each corresponding to a corresponding one of the caching agent circuits.

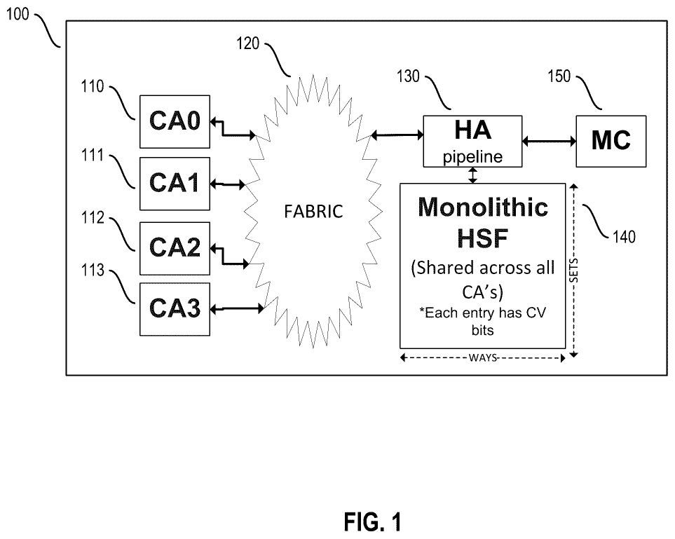

As mentioned in the background section, a computer system may include multiple cache memories, multiple caching agents, and one or more home agents that use a snoop filter to help control coherent access to memory space. Typically, a home agent uses a monolithic home snoop filter (HSF) as shown in FIG. 1.

FIG. 1 illustrates a monolithic home snoop filtering architecture 100. A snoop filtering architecture may include any number of caching agents (each a CA, e.g., CA0 110, CA1 111, CA2 112, CA3 113) interconnected to a home agent (HA) (e.g., HA 130) through an interconnection fabric (e.g., fabric 120). The HA may be connected to or include a monolithic inclusive HSF (e.g., HSF 140) and a memory controller (e.g., MC 150) to help control coherent access to memory space.

As a monolithic inclusive HSF, HSF 140 is shared across all CAs, and the format for an HSF entry includes a field for CA valid (CV) bits to identify the CA that currently owns a cache line (CL) within a group of consecutive cache lines (a sector, e.g., eight cache lines) corresponding to the entry (e.g., the format also includes a field for a tag to identify the cache sector). According to the architecture of FIG. 1, a first CA may own a first cache line in a sector and a second CA may own a second cache line in the same sector; therefore, more than one entry in the HSF may correspond to a single sector, so it may not be possible to identify, with the HSF, which CA owns which cache line.

In contrast, embodiments according to this specification may provide for identifying, with the HSF, which CA owns which cache line (i.e., precise cache line tracking). Thus, embodiments may provide any or all of the following features, which may be further described below:
Precise Cache Line Tracking—With a monolithic HSF, when two or more CAs access multiple cache lines of a sector, more than one CV bit is set. Precise cache line tracking is lost because there may be no way to identify the owners of the cache lines. Embodiments may provide for tracking the sectors accessed by each CA in its own HSF partition, thus providing precise tracking of each cache line naturally.
Snoop Overhead—With a monolithic HSF, due to imprecise ownership tracking, the home agent should snoop each CA which touched the sector to know if a given cache line has been accessed. Embodiments may provide for eliminating all these snoops because precise ownership is tracked.
Clean Eviction from CA—With a monolithic HSF, imprecise ownership tracking may prevent clearing the HSF entries during evictions. The HA should snoop the CAs to resolve ownership. If not snooped, the HSF will have zombie entries that may result in back invalidate snoops. Embodiments may provide for clearing the cache line (CL) bits within a sector entry, thus eliminating zombie entries.
Quality of Service (QOS) between CAs—With a monolithic HSF, QoS for each CA is not supported naturally. Extra logic may be needed to enforce QoS (e.g., guarantee effective cache size utilization in each CA by maintaining HSF way allocation for each CA). Embodiments may provide QoS for each CA naturally, because each CA may have a fixed HSF way allocation to guarantee effective cache size.
Noisy Neighbor Impact—With a monolithic HSF, HSF allocation due to a noisy CA may result in eviction of HSF entries and removal of cached data belonging to another CA, impacting its performance. Embodiments may provide for eliminating this noisy neighbor scenario.
HSF Scalability—With a monolithic HSF, the HSF scales with cache size per CA and the number of CAs. CV bits in each entry increase the die size scaling factor. Embodiments may provide for reducing the scaling factor by eliminating the CV bits.
HSF Modularity—With a monolithic HSF, the HSF should support SoC configurations having different numbers of CAs and different cache sizes per CA. The HSF should have CV bits to support the SoC configuration with the highest number of CAs, thus increasing die size. Varying cache size per CA may impact the QoS of the CA with a small cache size. Embodiments may provide modularity naturally, with one HSF partition per CA. The size of the HSF partition may be proportional to the cache size of the CA to which it is mapped.

These features may be increasingly desirable as core count in servers continue to rise. For example, in an embodiment, multiple CAs are distributed across multiple core dies (disaggregated) in a system (e.g., a system on a chip or SoC) that also includes one or more (e.g., two) input/output (I/O) dies. One or more (e.g., each) of the CAs may contain multiple cores with local caches (e.g., a level 0 or L0 cache, a level 1 or L1 cache, and a mid-level cache or MLC) and a common last level cache (LLC) shared among the cores. The caches store data and provide it to the cores at lower latency, thus improving core performance. Some (e.g., all) of the CAs may be connected to one or more (e.g., all) of the I/O dies, which may contain HSFs to maintain coherency among the multiple CAs.

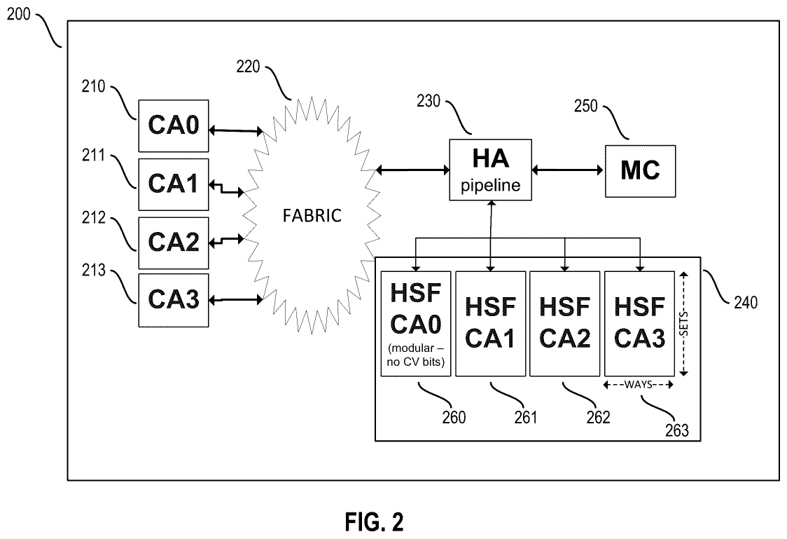

FIG. 2 illustrates a partitioned home snoop filtering architecture 200. A snoop filtering architecture may include any number of caching agents or caching agent circuits (each a CA, e.g., CA0 210, CA1 211, CA2 212, CA3 213) interconnected to a home agent or home agent circuit (e.g., HA 230) through an interconnection fabric (e.g., fabric 220). The HA may be connected to or include a partitioned inclusive HSF (e.g., HSF 240) and a memory controller (e.g., MC 250) to help control coherent access to memory space.

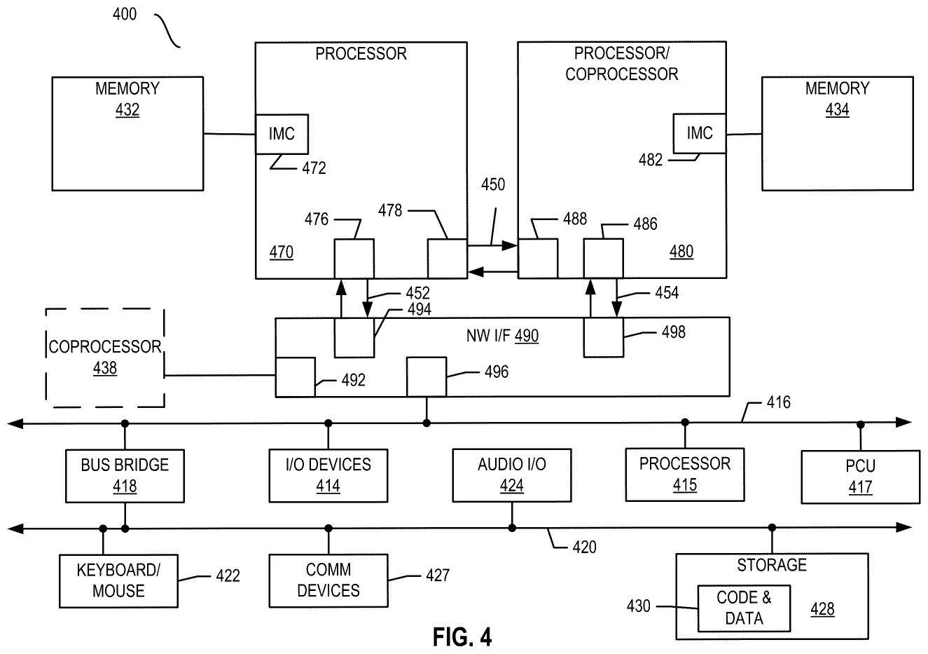

Partitioned home snoop filtering architecture 200 may be implemented in a computer system such as multiprocessor system 400 in FIG. 4. A caching agents and/or home agents according to embodiments may be implemented in circuitry, gates, logic, structures, hardware, etc., all or parts of which may be included in a discrete component and/or integrated into the circuitry of a processing device or any other apparatus in a computer or other information processing system

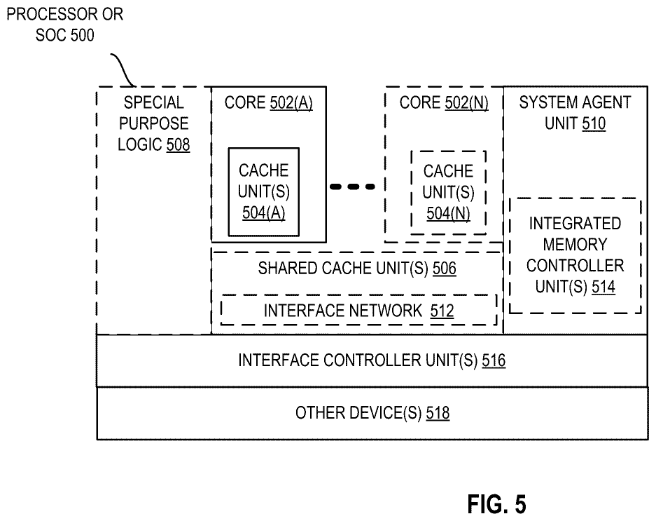

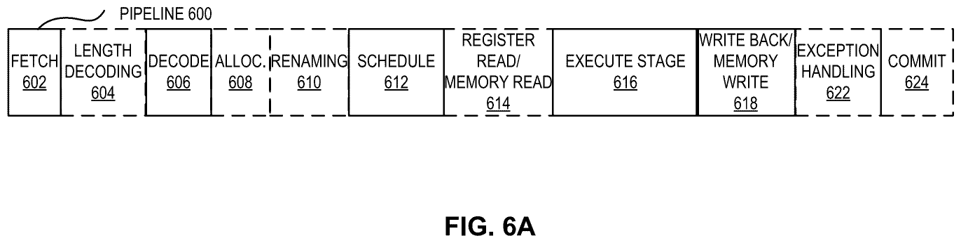

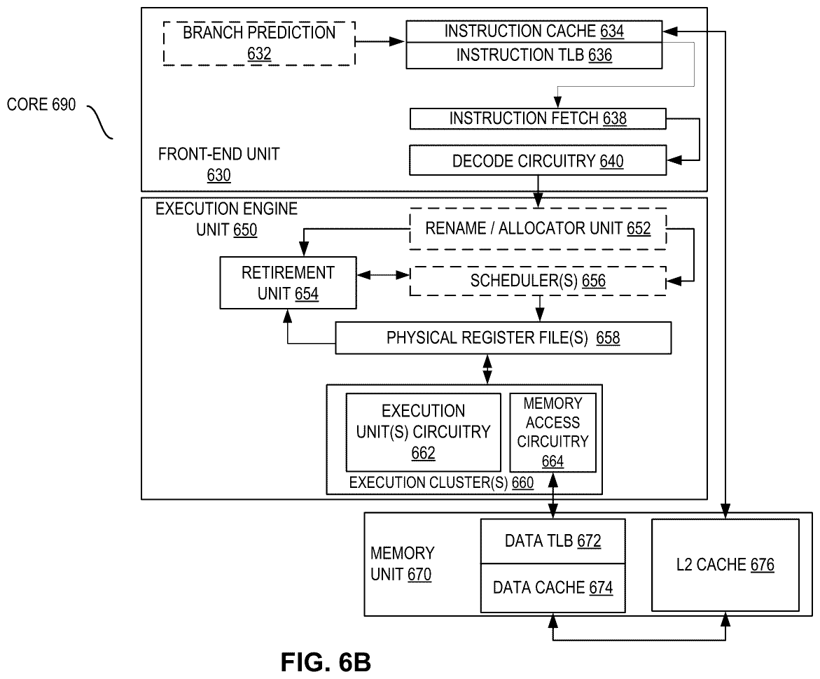

For example, any of CA0 210, CA1 211, CA2 212, CA3 213, and/or HA 230 may represent or include all or part of the circuitry of one or more hardware components including one or more processors, processor cores, or execution cores, such as any of processors 470, 480, or 415 in FIG. 4, processor 500 or one of cores 502A to 502N in FIG. 5, and/or core 690 in FIG. 6B, each as described below. Each such processor/core may be any type of processor/core, including a general-purpose microprocessor/core, such as a processor/core in the Intel® Core® Processor Family or other processor family from Intel® Corporation or another company, a special purpose processor or microcontroller, or any other device or component in an information processing system in which an embodiment may be implemented.

As a partitioned inclusive HSF, HSF 240 is modular and includes a partition per CA (e.g., HSF0 partition 260 corresponding to CA0 210, HSF1 partition 261 corresponding to CA1 211, HSF2 partition 262 corresponding to CA2 212, HSF3 partition 263 corresponding to CA3 213, etc.). In other words, each HSF partition is mapped to one CA (e.g., one CA die), with HSF entries being allocated as described below. Described yet another way, each CA has its own HSF partition.

Therefore, the CA that currently owns a cache line within a group of consecutive cache lines (a sector, where a sector may include any number of cache lines, e.g., eight) corresponding to the entry (e.g., the format includes a field for a tag to identify the cache sector) may be identified based on which HSF partition includes the entry, and the HSF entry format does not include a field for CV bits.

An example of an HSF entry format may include fields as shown in Table 1, in which the second column shows the number of bits per field in a monolithic HSF and the third column shows the number of bits per field in a partitioned HSF according to an embodiment. Note that number of bits for the CV field in a partitioned HSF entry is zero, which means that the entry has no CV field.

TABLE 1

| Field | Monolithic HSF | Partitioned HSF |
|---|---|---|
| Tag (to identify a sector) | 18 | 18 |
| CV (CA valid) | 4 | 0 |
| nCL page state | 1 | 1 |
| CL valid | 8 | 8 |
| ECC (error correcting code) | 7 | 7 |
| Total | 38 | 34 |

The example of Table 1 corresponds to a 512-byte sector size (eight 64-byte cache lines per sector, hence the CL field size is eight bits (one per cache line in the sector identified by the corresponding tag). The example also corresponds to an architecture with four CAs, hence the CV field size for the monolithic HSF is four bits (one per CA). The state field size may be any number of bits and maybe depend on the cache coherency protocol (e.g., MESI (modified, exclusive, shared, invalid)), and is shown as one bit (e.g., clean (modified) or dirty (exclusive or shared)).

Furthering this example, the total HSF area for a 10.5 MB LLC, 3 MB MLC per core, and 96 cores with a 6.3× coverage factor would be approximately 87 MB using a monolithic HSF and 78 MB using a partitioned HSF according to an embodiment.

HSF allocation, HSF precise tracking, clean eviction, and HSF back invalidation using a partitioned HSF according to embodiments is described and compared to HSF allocation, HSF precise tracking, clean eviction, and HSF back invalidation using a monolithic HSF as follows (with references to FIGS. 1 and 2):

HSF Allocation (e.g., CA0 accesses a cache line (CL0 of sector S) and no corresponding entry (i.e., for CA0 and CL0 of sector S) is present in the HSF).
Monolithic HSF—The HA performs a look up for a sector tag match in the HSF. In the case of an HSF miss, the HA creates a new HSF entry with appropriate sector tag bits, sets bit 0 (corresponding to CL0) of the CL valid bits, and sets bit 0 (corresponding to CA0) of the CV bits. In the case of an HSF hit (i.e., a CA already accessed a different cache line in sector S), the HA sets bit 0 (corresponding to CL0) of the CL valid bits and, if not already set (e.g., CA0 already accessed a different cache line in sector S), sets bit 0 (corresponding to CA0) of the CV bits.
Partitioned HSF—The HA performs a look up for a sector tag match in CA0's HSF partition. In the case of an HSF miss, the HA creates a new entry, with appropriate sector tag bits, in CA0's HSF partition and sets bit 0 (corresponding to CL0) of the CL valid bits. In the case of an HSF hit (i.e., CA0 already accessed a different cache line in sector S), the HA sets bit 0 (corresponding to CL0) of the CL valid bits. Note that in CL0's HSF partition, in this scenario, the CL valid bit for CL0 in sector S will not already be set, as one might be in a monolithic HSF.

### HSF Precise Tracking

Monolithic HSF—When multiple CA valid bits and CL valid bits are set in a monolithic HSF entry, the HA loses its ability to precisely identify which cache lines are owned by a CA. To illustrate the scenario, assume CA0 accesses the first cache line (CL0) of a sector that is not yet present in the monolithic HSF. The HA creates an HSF entry with the appropriate sector tag, sets bit 0 of the CL valid bits, and sets bit 0 of the CA valid bits. Later, if CA1 accesses the second cache line (CL1) of the sector, the HA sets bit 1 of the same entry's CA valid bits and bit 1 of the same entry's CL valid bits. As a result, the HA cannot identify the CA owner (between CA0 and CA1) for the two cache lines (CL0 and CL1) and hence loses the ability to precisely track ownership at cache line granularity.
Partitioned HSF—When multiple CAs access a sector in a partitioned HSF architecture, entries are created within their HSF partition and thus help with precise tracking ownership of every cache line. Using the same scenario described above, CA0 creates a sector entry with CL0 bit set in HSF0 partition and CA1 creates a sector entry with CL1 bit set in HSF1 partition. Both these entries will have the same tag. During look up, the HA does a tag match across all the ways of a set in all the HSF partitions to resolve the ownership. This precise tracking eliminates the snoops to CAs in case of data sharing across the CAs.

### Clean Eviction

Monolithic HSF—When a CA evicts a clean cache line in an architecture with a monolithic HSF, the HSF cannot clear the CL valid bit directly if there are multiple CA bits set for that sector. Consider the scenario of CA0 and CA1 each accessing one cache line (CL0 and CL1, respectively) of a sector. When CA0 evicts CL0, the HA cannot resolve the ownership between CA0 and CA1 and thus snoops CA1, to identify if CL0 exists, before it may clear the CL0 bit in the HSF.
Partitioned HSF—When a CA evicts a clean cache line in an architecture with a partitioned HSF, the HA searches for the entry in the corresponding HSF partition and clears the CL valid entry. Using the same scenario described above, if CA0 evicts CL0, HA does a tag look up in HSF0, and clears the CL0 bit of the sector entry.

HSF Back Invalidation (when all the ways of a set are occupied, the HA decides to invalidate a sector in one of the ways to create space for a new request; e.g., consider the scenario of CA0 accessing a new cache line which results in allocating a new sector in the HSF to a set which has no free way)
Monolithic HSF—The HA may use a random replacement policy to identify a way to be evicted in the set. Using the CA valid bits set in the way being evicted, the HA sends back invalidation to the CAs. The way being evicted can be owned by CA0 or by other CAs (CA1, CA2, CA3) or shared between one or more CAs. For example, if the way being evicted is owned by CA1, the HA might be evicting a useful entry from CA1 and may impact its performance. A side effect of invalidating possibly useful CA1 entries is that CA1 may try to allocate these entries again and may back invalidate CA0 entries.
Partitioned HSF—The HA may use a random replacement policy in the HSF0 partition mapped to CA0. The back invalidations go only to CA0 only and do not affect the state of other CAs.

In embodiments, a partitioned HSF may be sized for the worst case non-sharing workloads (which do not share data among threads) that is more than the sharing workloads (which shares data among threads), so as to mitigate the impact of creating one entry per HSF partition when CAs share data (compared to creating just one shared entry in a monolithic HSF).

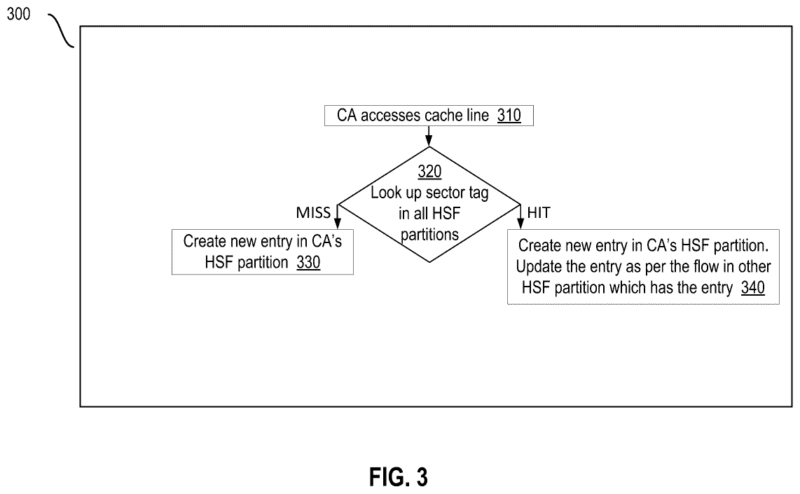

FIG. 3 illustrates a method 300 for partitioned snoop filtering according to an embodiment. Method 300 may be performed by and/or in connection with the operation of an apparatus based on a partitioned home snoop filtering architecture such as that shown FIG. 2; therefore, all or any portion of the preceding description of or related to FIG. 2 may be applicable to method 300.

In 310, a CA (e.g., CA0) accesses a cache line (e.g., CL0 of sector S) for which no corresponding entry (i.e., for CA0 and CL0 of sector S) is present in an HSF. In 320, the HA performs a look up for a sector tag match in all HSF partitions. In the case of an HSF miss, in 330, the HA creates a new entry, with appropriate sector tag bits, in CA0's HSF partition and sets bit 0 (corresponding to CL0) of the CL valid bits. In the case of an HSF hit (e.g., a different (other) CA (e.g., CA1) already accessed a different cache line in sector S), in 340, the HA creates a new entry in the first CA's (e.g., CA0's) HSF partition, to be updated as described above (e.g., as for the other CA's HSF partition existing entry).

### Example Apparatuses, Methods, Etc.

According to some examples, an apparatus (e.g., a processing device) includes multiple caching agent circuits and a home agent circuit. The home agent circuit controls cache coherency using a snoop filter including multiple partitions, each corresponding to a corresponding one of the caching agent circuits.

Any such examples may include any or any combination of the following aspects. A first of the plurality of partitions is to store entries corresponding only to a first of the caching agent circuits. Each of the plurality of partitions is to store entries for only its corresponding caching agent circuit. The home agent circuit, in response to an access by a first caching agent circuit to a first cache line in a sector, is to perform a first snoop filter look up in a partition corresponding to the first caching agent circuit. The home agent circuit, in response to the first snoop filter look up missing, is to create a first entry for the sector in the partition corresponding to the first caching agent circuit. The home agent circuit, in response to the first snoop filter look up hitting an entry, is to set, in the entry, a bit corresponding to the first cache line. The home agent circuit, in response to an access by a second caching agent circuit to a second cache line in the sector, is to perform a second snoop filter look up in a partition corresponding to the second caching agent circuit. The home agent circuit, in response to the second snoop filter look up missing, is to create a second entry for the sector in the partition corresponding to the second caching agent circuit. Creating the first entry includes storing a first tag in the first entry and creating the second entry includes storing the first tag in the second entry. To resolve ownership of the first cache line or the second cache line, the home agent circuit performs a tag match in at least the partition corresponding to the first caching agent circuit and the partition corresponding to the second caching agent circuit instead of snooping the first caching agent circuit and the second caching agent circuit. In response to the first caching agent circuit evicting the first cache line, the home agent circuit clears, in the first entry, a bit corresponding to the first cache line instead of snooping the second caching agent circuit. In connection with creating a third entry in the partition corresponding to the first caching agent circuit, the home agent circuit invalidates only the first entry of the first entry and the second entry.

According to some examples, a method includes performing, by a home agent in response to an access by a first caching agent to a first cache line in a sector, a first snoop filter look up in a snoop filter partition corresponding to the first caching agent, wherein the snoop filter partition is one a plurality of snoop filter partitions, wherein each snoop filter partition corresponds to one of a plurality of caching agents; creating, by the home agent in response to the first snoop filter look up missing, a first entry for the sector in the snoop filter partition corresponding to the first caching agent; and setting in a second entry, by the home agent in response to the first snoop filter look up hitting the second entry, a bit corresponding to the first cache line.

Any such examples may include any or any combination of the following aspects. The method includes performing, by the home agent in response to an access by a second caching agent to a second cache line in the sector, a second snoop filter look up in a snoop filter partition corresponding to the second caching agent. Wherein creating the first entry includes storing a first tag in the first entry, the method includes creating, by the home agent, in response to the second snoop filter look up missing, a second entry for the sector in the snoop filter partition corresponding to the second caching agent, wherein creating the second entry includes storing the first tag in the second entry. The method includes performing, by the home agent in connection with resolving ownership of the first cache line or the second cache line, a tag match in at least the snoop filter partition corresponding to the first caching agent and the snoop filter partition corresponding to the second caching agent instead of snooping the first caching agent and the second caching agent. The method includes clearing, by the home agent in response to the first caching agent evicting the first cache line, a bit in the first entry corresponding to the first cache line instead of snooping the second caching agent. The method includes invalidating, by the home agent in connection with creating a third entry in the snoop filter partition corresponding to the first caching agent, only the first entry of the first entry and the second entry.

According to some examples, a system includes a system memory, a memory controller to control the system memory, a plurality of caching agents to cache data from the system memory, and a home agent connect to the plurality of caching agents and the memory controller to control cache coherency using a snoop filter including a plurality of partitions, wherein each partition corresponds to one of the plurality of caching agents.

Any such examples may include any or any combination of the following aspects. A first of the plurality of partitions is to store entries corresponding only to a first of the caching agents. Each of the plurality of partitions is to store entries for only to its corresponding caching agent. The home agent, in response to an access by a first caching agent to a first cache line in a sector, is to perform a first snoop filter look up in a partition corresponding to the first caching agent. The home agent, in response to the first snoop filter look up missing, is to create a first entry for the sector in the partition corresponding to the first caching agent. The home agent, in response to the first snoop filter look up hitting an entry, is to set, in the entry, a bit corresponding to the first cache line. The home agent, in response to an access by a second caching agent to a second cache line in the sector, is to perform a second snoop filter look up in a partition corresponding to the second caching agent. The home agent, in response to the second snoop filter look up missing, is to create a second entry for the sector in the partition corresponding to the second caching agent. Creating the first entry includes storing a first tag in the first entry and creating the second entry includes storing the first tag in the second entry. To resolve ownership of the first cache line or the second cache line, the home agent performs a tag match in at least the partition corresponding to the first caching agent and the partition corresponding to the second caching agent instead of snooping the first caching agent and the second caching agent. In response to the first caching agent evicting the first cache line, the home agent clears, in the first entry, a bit corresponding to the first cache line instead of snooping the second caching agent. In connection with creating a third entry in the partition corresponding to the first caching agent, the home agent invalidates only the first entry of the first entry and the second entry.

According to some examples, an apparatus may include means for performing any function disclosed herein; an apparatus may include a data storage device that stores code that when executed by a hardware processor or controller causes the hardware processor or controller to perform any method or portion of a method disclosed herein; an apparatus, method, system etc. may be as described in the detailed description; a non-transitory machine-readable medium may store instructions that when executed by a machine causes the machine to perform any method or portion of a method disclosed herein. Embodiments may include any details, features, etc. or combinations of details, features, etc. described in this specification.

### Example Computer Architectures

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 4 illustrates an example computing system. Multiprocessor system 400 is an interfaced system and includes a plurality of processors or cores including a first processor 470 and a second processor 480 coupled via an interface 450 such as a point-to-point (P-P) interconnect, a fabric, and/or bus. In some examples, the first processor 470 and the second processor 480 are homogeneous. In some examples, the first processor 470 and the second processor 480 are heterogenous. Though the example system 400 is shown to have two processors, the system may have three or more processors, or may be a single processor system. In some examples, the computing system is a system on a chip (SoC).

Processors 470 and 480 are shown including integrated memory controller (IMC) circuitry 472 and 482, respectively. Processor 470 also includes interface circuits 476 and 478; similarly, second processor 480 includes interface circuits 486 and 488. Processors 470, 480 may exchange information via the interface 450 using interface circuits 478, 488. IMCs 472 and 482 couple the processors 470, 480 to respective memories, namely a memory 432 and a memory 434, which may be portions of main memory locally attached to the respective processors.

Processors 470, 480 may each exchange information with a network interface (NW I/F) 490 via individual interfaces 452, 454 using interface circuits 476, 494, 486, 498. The network interface 490 (e.g., one or more of an interconnect, bus, and/or fabric, and in some examples is a chipset) may optionally exchange information with a coprocessor 438 via an interface circuit 492. In some examples, the coprocessor 438 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 470, 480 or outside of both processors, yet connected with the processors via an interface such as P-P interconnect, such that either or both processors' local cache information may be stored in the shared cache if a processor is placed into a low power mode.

Network interface 490 may be coupled to a first interface 416 via interface circuit 496. In some examples, first interface 416 may be an interface such as a Peripheral Component Interconnect (PCI) interconnect, a PCI Express interconnect or another I/O interconnect. In some examples, first interface 416 is coupled to a power control unit (PCU) 417, which may include circuitry, software, and/or firmware to perform power management operations with regard to the processors 470, 480 and/or co-processor 438. PCU 417 provides control information to a voltage regulator (not shown) to cause the voltage regulator to generate the appropriate regulated voltage. PCU 417 also provides control information to control the operating voltage generated. In various examples, PCU 417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 417 is illustrated as being present as logic separate from the processor 470 and/or processor 480. In other cases, PCU 417 may execute on a given one or more of cores (not shown) of processor 470 or 480. In some cases, PCU 417 may be implemented as a microcontroller (dedicated or general-purpose) or other control logic configured to execute its own dedicated power management code, sometimes referred to as P-code. In yet other examples, power management operations to be performed by PCU 417 may be implemented externally to a processor, such as by way of a separate power management integrated circuit (PMIC) or another component external to the processor. In yet other examples, power management operations to be performed by PCU 417 may be implemented within BIOS or other system software.

Various I/O devices 414 may be coupled to first interface 416, along with a bus bridge 418 which couples first interface 416 to a second interface 420. In some examples, one or more additional processor(s) 415, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 416. In some examples, second interface 420 may be a low pin count (LPC) interface. Various devices may be coupled to second interface 420 including, for example, a keyboard and/or mouse 422, communication devices 427 and storage circuitry 428. Storage circuitry 428 may be one or more non-transitory machine-readable storage media as described below, such as a disk drive or other mass storage device which may include instructions/code and data 430. Further, an audio I/O 424 may be coupled to second interface 420. Note that other architectures than the point-to-point architecture described above are possible. For example, instead of the point-to-point architecture, a system such as multiprocessor system 400 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 5 illustrates a block diagram of an example processor and/or SoC 500 that may have one or more cores and an integrated memory controller. The solid lined boxes illustrate a processor 500 with a single core 502(A), system agent unit circuitry 510, and a set of one or more interface controller unit(s) circuitry 516, while the optional addition of the dashed lined boxes illustrates an alternative processor 500 with multiple cores 502(A)-(N), a set of one or more integrated memory controller unit(s) circuitry 514 in the system agent unit circuitry 510, and special purpose logic 508, as well as a set of one or more interface controller units circuitry 516. Note that the processor 500 may be one of the processors 470 or 480, or co-processor 438 or 415 of FIG. 4.

Thus, different implementations of the processor 500 may include: 1) a CPU with the special purpose logic 508 being integrated graphics and/or scientific (throughput) logic (which may include one or more cores, not shown), and the cores 502(A)-(N) being one or more general purpose cores (e.g., general purpose in-order cores, general purpose out-of-order cores, or a combination of the two); 2) a coprocessor with the cores 502(A)-(N) being a large number of special purpose cores intended primarily for graphics and/or scientific (throughput); and 3) a coprocessor with the cores 502(A)-(N) being a large number of general purpose in-order cores. Thus, the processor 500 may be a general-purpose processor, coprocessor, or special-purpose processor, such as, for example, a network or communication processor, compression engine, graphics processor, GPGPU (general purpose graphics processing unit), a high throughput many integrated cores (MIC) coprocessor (including 30 or more cores), embedded processor, or the like. The processor may be implemented on one or more chips. The processor 500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 504(A)-(N) within the cores 502(A)-(N), a set of one or more shared cache unit(s) circuitry 506, and external memory (not shown) coupled to the set of integrated memory controller unit(s) circuitry 514. The set of one or more shared cache unit(s) circuitry 506 may include one or more mid-level caches, such as level 2 (L2), level 3 (L3), level 4 (L4), or other levels of cache, such as a last level cache (LLC), and/or combinations thereof. While in some examples interface network circuitry 512 (e.g., a ring interconnect) interfaces the special purpose logic 508 (e.g., integrated graphics logic), the set of shared cache unit(s) circuitry 506, and the system agent unit circuitry 510, alternative examples use any number of well-known techniques for interfacing such units. In some examples, coherency is maintained between one or more of the shared cache unit(s) circuitry 506 and cores 502(A)-(N). In some examples, interface controller unit circuitry 516 couples the cores 502 to one or more other devices 518 such as one or more I/O devices, storage, one or more communication devices (e.g., wireless networking, wired networking, etc.), etc.

In some examples, one or more of the cores 502(A)-(N) are capable of multi-threading. The system agent unit circuitry 510 includes those components coordinating and operating cores 502(A)-(N). The system agent unit circuitry 510 may include, for example, power control unit (PCU) circuitry and/or display unit circuitry (not shown). The PCU may be or may include logic and components needed for regulating the power state of the cores 502(A)-(N) and/or the special purpose logic 508 (e.g., integrated graphics logic). The display unit circuitry is for driving one or more externally connected displays.

The cores 502(A)-(N) may be homogenous in terms of instruction set architecture (ISA). Alternatively, the cores 502(A)-(N) may be heterogeneous in terms of ISA; that is, a subset of the cores 502(A)-(N) may be capable of executing an ISA, while other cores may be capable of executing only a subset of that ISA or another ISA.

### Example Core Architectures—In-Order and Out-of-Order Core Block Diagram.

FIG. 6A is a block diagram illustrating both an example in-order pipeline and an example register renaming, out-of-order issue/execution pipeline according to examples. FIG. 6B is a block diagram illustrating both an example in-order architecture core and an example register renaming, out-of-order issue/execution architecture core to be included in a processor according to examples. The solid lined boxes in FIGS. 6A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6A, a processor pipeline 600 includes a fetch stage 602, an optional length decoding stage 604, a decode stage 606, an optional allocation (Alloc) stage 608, an optional renaming stage 610, a schedule (also known as a dispatch or issue) stage 612, an optional register read/memory read stage 614, an execute stage 616, a write back/memory write stage 618, an optional exception handling stage 622, and an optional commit stage 624. One or more operations can be performed in each of these processor pipeline stages. For example, during the fetch stage 602, one or more instructions are fetched from instruction memory, and during the decode stage 606, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 606 and the register read/memory read stage 614 may be combined into one pipeline stage. In one example, during the execute stage 616, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 6B may implement the pipeline 600 as follows: 1) the instruction fetch circuitry 638 performs the fetch and length decoding stages 602 and 604; 2) the decode circuitry 640 performs the decode stage 606; 3) the rename/allocator unit circuitry 652 performs the allocation stage 608 and renaming stage 610; 4) the scheduler(s) circuitry 656 performs the schedule stage 612; 5) the physical register file(s) circuitry 658 and the memory unit circuitry 670 perform the register read/memory read stage 614; the execution cluster(s) 660 perform the execute stage 616; 6) the memory unit circuitry 670 and the physical register file(s) circuitry 658 perform the write back/memory write stage 618; 7) various circuitry may be involved in the exception handling stage 622; and 8) the retirement unit circuitry 654 and the physical register file(s) circuitry 658 perform the commit stage 624.

FIG. 6B shows a processor core 690 including front-end unit circuitry 630 coupled to execution engine unit circuitry 650, and both are coupled to memory unit circuitry 670. The core 690 may be a reduced instruction set architecture computing (RISC) core, a complex instruction set architecture computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front-end unit circuitry 630 may include branch prediction circuitry 632 coupled to instruction cache circuitry 634, which is coupled to an instruction translation lookaside buffer (TLB) 636, which is coupled to instruction fetch circuitry 638, which is coupled to decode circuitry 640. In one example, the instruction cache circuitry 634 is included in the memory unit circuitry 670 rather than the front-end circuitry 630. The decode circuitry 640 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 640 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 640 may be implemented using various different mechanisms. Examples of suitable mechanisms include, but are not limited to, look-up tables, hardware implementations, programmable logic arrays (PLAs), microcode read only memories (ROMs), etc. In one example, the core 690 includes a microcode ROM (not shown) or other medium that stores microcode for certain macroinstructions (e.g., in decode circuitry 640 or otherwise within the front-end circuitry 630). In one example, the decode circuitry 640 includes a micro-operation (micro-op) or operation cache (not shown) to hold/cache decoded operations, micro-tags, or micro-operations generated during the decode or other stages of the processor pipeline 600. The decode circuitry 640 may be coupled to rename/allocator unit circuitry 652 in the execution engine circuitry 650.

The execution engine circuitry 650 includes the rename/allocator unit circuitry 652 coupled to retirement unit circuitry 654 and a set of one or more scheduler(s) circuitry 656. The scheduler(s) circuitry 656 represents any number of different schedulers, including reservations stations, central instruction window, etc. In some examples, the scheduler(s) circuitry 656 can include arithmetic logic unit (ALU) scheduler/scheduling circuitry, ALU queues, address generation unit (AGU) scheduler/scheduling circuitry, AGU queues, etc. The scheduler(s) circuitry 656 is coupled to the physical register file(s) circuitry 658. Each of the physical register file(s) circuitry 658 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 658 includes vector registers unit circuitry, writemask registers unit circuitry, and scalar register unit circuitry. These register units may provide architectural vector registers, vector mask registers, general-purpose registers, etc. The physical register file(s) circuitry 658 is coupled to the retirement unit circuitry 654 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 654 and the physical register file(s) circuitry 658 are coupled to the execution cluster(s) 660. The execution cluster(s) 660 includes a set of one or more execution unit(s) circuitry 662 and a set of one or more memory access circuitry 664. The execution unit(s) circuitry 662 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 656, physical register file(s) circuitry 658, and execution cluster(s) 660 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 664). It should also be understood that where separate pipelines are used, one or more of these pipelines may be out-of-order issue/execution and the rest in-order.

In some examples, the execution engine unit circuitry 650 may perform load store unit (LSU) address/data pipelining to an Advanced Microcontroller Bus (AMB) interface (not shown), and address phase and writeback, data phase load, store, and branches.

The set of memory access circuitry 664 is coupled to the memory unit circuitry 670, which includes data TLB circuitry 672 coupled to data cache circuitry 674 coupled to level 2 (L2) cache circuitry 676. In one example, the memory access circuitry 664 may include load unit circuitry, store address unit circuitry, and store data unit circuitry, each of which is coupled to the data TLB circuitry 672 in the memory unit circuitry 670. The instruction cache circuitry 634 is further coupled to the level 2 (L2) cache circuitry 676 in the memory unit circuitry 670. In one example, the instruction cache 634 and the data cache 674 are combined into a single instruction and data cache (not shown) in L2 cache circuitry 676, level 3 (L3) cache circuitry (not shown), and/or main memory. The L2 cache circuitry 676 is coupled to one or more other levels of cache and eventually to a main memory.

The core 690 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 690 includes logic to support a packed data instruction set architecture extension (e.g., AVX1, AVX2), thereby allowing the operations used by many multimedia applications to be performed using packed data.

### Example Execution Unit(s) Circuitry.

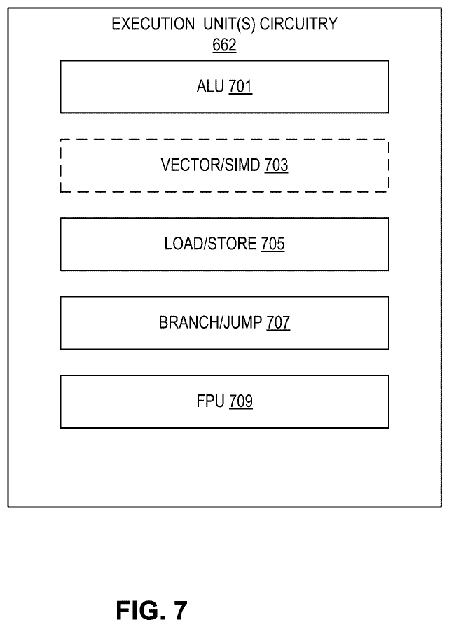

FIG. 7 illustrates examples of execution unit(s) circuitry, such as execution unit(s) circuitry 662 of FIG. 6B. As illustrated, execution unit(s) circuitry 662 may include one or more ALU circuits 701, optional vector/single instruction multiple data (SIMD) circuits 703, load/store circuits 705, branch/jump circuits 707, and/or Floating-point unit (FPU) circuits 709. ALU circuits 701 perform integer arithmetic and/or Boolean operations. Vector/SIMD circuits 703 perform vector/SIMD operations on packed data (such as SIMD/vector registers). Load/store circuits 705 execute load and store instructions to load data from memory into registers or store from registers to memory. Load/store circuits 705 may also generate addresses. Branch/jump circuits 707 cause a branch or jump to a memory address depending on the instruction. FPU circuits 709 perform floating-point arithmetic. The width of the execution unit(s) circuitry 662 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

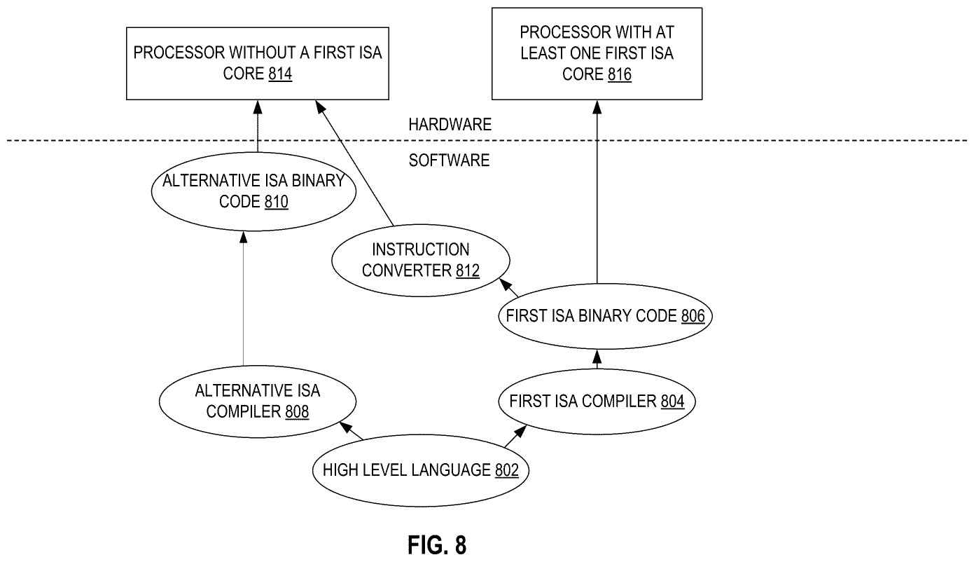

FIG. 8 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 8 shows a program in a high-level language 802 may be compiled using a first ISA compiler 804 to generate first ISA binary code 806 that may be natively executed by a processor with at least one first ISA core 816. The processor with at least one first ISA core 816 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 804 represents a compiler that is operable to generate first ISA binary code 806 (e.g., object code) that can, with or without additional linkage processing, be executed on the processor with at least one first ISA core 816. Similarly, FIG. 8 shows the program in the high-level language 802 may be compiled using an alternative ISA compiler 808 to generate alternative ISA binary code 810 that may be natively executed by a processor without a first ISA core 814. The instruction converter 812 is used to convert the first ISA binary code 806 into code that may be natively executed by the processor without a first ISA core 814. This converted code is not necessarily to be the same as the alternative ISA binary code 810; however, the converted code will accomplish the general operation and be made up of instructions from the alternative ISA. Thus, the instruction converter 812 represents software, firmware, hardware, or a combination thereof that, through emulation, simulation, or any other process, allows a processor or other electronic device that does not have a first ISA processor or core to execute the first ISA binary code 806.

References to “one example,” “an example,” “one embodiment,” “an embodiment,” etc., indicate that the example or embodiment described may include a particular feature, structure, or characteristic, but every example or embodiment may not necessarily include the particular feature, structure, or characteristic. Moreover, such phrases do not necessarily refer to the same example or embodiment. Further, when a particular feature, structure, or characteristic is described in connection with an example or embodiment, it is submitted that it is within the knowledge of one skilled in the art to affect such feature, structure, or characteristic in connection with other examples or embodiments whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C). As used in this specification and the claims and unless otherwise specified, the use of the ordinal adjectives “first,” “second,” “third,” etc. to describe an element merely indicates that a particular instance of an element or different instances of like elements are being referred to and is not intended to imply that the elements so described must be in a particular sequence, either temporally, spatially, in ranking, or in any other manner. Also, as used in descriptions of embodiments, a “/” character between terms may mean that what is described may include or be implemented using, with, and/or according to the first term and/or the second term (and/or any other additional terms).

Also, the terms “bit,” “flag,” “field,” “entry,” “indicator,” etc., may be used to describe any type or content of a storage location in a register, table, database, or other data structure, whether implemented in hardware or software, but are not meant to limit embodiments to any particular type of storage location or number of bits or other elements within any particular storage location. For example, the term “bit” may be used to refer to a bit position within a register and/or data stored or to be stored in that bit position. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments to any particular logical convention, as any logical convention may be used within embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
a plurality of caching agent circuits; and
a home agent circuit to control cache coherency using a snoop filter including a plurality of partitions, wherein each partition corresponds to a corresponding one of the plurality of caching agent circuits.

2. The apparatus of claim 1, wherein a first of the plurality of partitions is to store entries corresponding only to a first of the caching agent circuits.

3. The apparatus of claim 1, wherein each of the plurality of partitions is to store entries for only its corresponding caching agent circuit.

4. The apparatus of claim 1, wherein the home agent circuit, in response to an access by a first caching agent circuit to a first cache line in a sector, is to perform a first snoop filter look up in a partition corresponding to the first caching agent circuit.

5. The apparatus of claim 4, wherein the home agent circuit, in response to the first snoop filter look up missing, is to create a first entry for the sector in the partition corresponding to the first caching agent circuit.

6. The apparatus of claim 4, wherein the home agent circuit, in response to the first snoop filter look up hitting an entry, is to set, in the entry, a bit corresponding to the first cache line.

7. The apparatus of claim 5, wherein the home agent circuit, in response to an access by a second caching agent circuit to a second cache line in the sector, is to perform a second snoop filter look up in a partition corresponding to the second caching agent circuit.

8. The apparatus of claim 7, wherein the home agent circuit, in response to the second snoop filter look up missing, is to create a second entry for the sector in the partition corresponding to the second caching agent circuit.

9. The apparatus of claim 8, wherein creating the first entry includes storing a first tag in the first entry and creating the second entry includes storing the first tag in the second entry.

10. The apparatus of claim 9, wherein to resolve ownership of the first cache line or the second cache line, the home agent circuit performs a tag match in at least the partition corresponding to the first caching agent circuit and the partition corresponding to the second caching agent circuit instead of snooping the first caching agent circuit and the second caching agent circuit.

11. The apparatus of claim 8, wherein in response to the first caching agent circuit evicting the first cache line, the home agent circuit clears, in the first entry, a bit corresponding to the first cache line instead of snooping the second caching agent circuit.

12. The apparatus of claim 8, wherein in connection with creating a third entry in the partition corresponding to the first caching agent circuit, the home agent circuit invalidates only the first entry of the first entry and the second entry.

13. A method comprising:
performing, by a home agent in response to an access by a first caching agent to a first cache line in a sector, a first snoop filter look up in a snoop filter partition corresponding to the first caching agent, wherein the snoop filter partition is one a plurality of snoop filter partitions, wherein each snoop filter partition corresponds to a corresponding one of a plurality of caching agents;
creating, by the home agent in response to the first snoop filter look up missing, a first entry for the sector in the snoop filter partition corresponding to the first caching agent; and
setting in a second entry, by the home agent in response to the first snoop filter look up hitting the second entry, a bit corresponding to the first cache line.

14. The method of claim 13, further comprising performing, by the home agent in response to an access by a second caching agent to a second cache line in the sector, a second snoop filter look up in a snoop filter partition corresponding to the second caching agent.

15. The method of claim 14, wherein creating the first entry includes storing a first tag in the first entry, further comprising creating, by the home agent, in response to the second snoop filter look up missing, a second entry for the sector in the snoop filter partition corresponding to the second caching agent, wherein creating the second entry includes storing the first tag in the second entry.

16. The method of claim 15, further comprising performing, by the home agent in connection with resolving ownership of the first cache line or the second cache line, a tag match in at least the snoop filter partition corresponding to the first caching agent and the snoop filter partition corresponding to the second caching agent instead of snooping the first caching agent and the second caching agent.

17. The method of claim 14, further comprising clearing, by the home agent in response to the first caching agent evicting the first cache line, a bit in the first entry corresponding to the first cache line instead of snooping the second caching agent.

18. The method of claim 14, further comprising invalidating, by the home agent in connection with creating a third entry in the snoop filter partition corresponding to the first caching agent, only the first entry of the first entry and the second entry.

19. A system comprising:
a system memory;
a memory controller to control the system memory;
a plurality of caching agents to cache data from the system memory; and
a home agent connect to the plurality of caching agents and the memory controller to control cache coherency using a snoop filter including a plurality of partitions, wherein each partition corresponds to a corresponding one of the plurality of caching agents.

20. The system of claim 19, wherein each of the plurality of partitions is to store entries for only its corresponding caching agent.
